(19) United States
(12) Patent Application Publication
(10) Pub. No.: US 2021/0339057 A1
(43) Pub. Date: Nov. 4, 2021

(54) MULTIPURPOSE PROTECTIVE RESPIRATORY HEADGEAR WITH ANTERIORLY MOUNTED EXCHANGEABLE CARTRIDGE

(71) Applicant: Oneg HaKarmel Ltd., Tirat Carmel (IL)

(72) Inventors: Noam GAVRIELY, Haifa (IL); David ASHKENAZI, Tel Aviv (IL)

(73) Assignee: Oneg HaKarmel Ltd., Tirat Carmel (IL)

(21) Appl. No.: 17/306,571

(22) Filed: May 3, 2021

(30) Foreign Application Priority Data
May 3, 2020 (GB) 2006519.9

(51) Int. Cl. A62B 7/10; A41D 13/11; A62B 18/02; A62B 23/02; B01D 46/24

(52) U.S. Cl. CPC A62B 7/10; A41D 13/1184; B01D 2279/40; A62B 23/02; B01D 46/2411; A62B 18/02

(57) ABSTRACT

A protective respiratory system including: a multipurpose protective respiratory headgear including a nasolabial portion with triangular extrusion shape and an essentially rectangular horizontal recess, configured to receive an exchangeable filter cartridge, and an anteriorly mounted exchangeable filter cartridge, with a structured posterior outlet aperture, as well as method of using the same are described.

### CROSS-REFERENCE TO RELATED APPLICATIONS

The present application claims the benefit of priority under Paris convention to GB 2006519.9 filed 2020 May 3, the contents of which is incorporated herein by its entirety by this reference.

### TECHNICAL FIELD

In general, the present invention pertains to the art of personal protective equipment. In particular, the invention relates to a multipurpose protective respiratory headgear, with anteriorly mounted exchangeable cartridge, as well as to methods of using the same.

### BACKGROUND ART

It is believed that the current state of the art is represented by the following patent literature: U.S. Pat. Nos. 8,517,023, 8,397,727 and 8,783,252.

U.S. Pat. No. 8,517,023 which is believed to represent the closest prior art teaches an A mask system for delivering breathable gas to a patient includes a common frame provided without built-in or integral headgear attachment points and at least first and second headgear connectors adapted to be provided to the frame.

Each of the at least first and second headgear connectors are adapted to attach headgear straps of headgear. The at least first and second headgear connectors are different from one another in at least one aspect.

The common N95 respirator is recommended by the US Centers for Disease Control and Prevention (CDC) for most cases of air contamination. N95 filters are designed to seal around mouth and nose and are designed to block at least 95% of particulate matter sized 0.3 micron or larger in diameter. N95 respirator are also known for relative difficulty to breathe through and their full effectiveness also depends on a good fit.

In contrast, surgical masks, which are standard for staff in hospital operating rooms and are often recommended to the public in order to avoid seasonal flu, do not carry a NIOSH rating. Surgical masks are designed to filter out relatively large particles, such as blood and sputum droplets and hair.

### SUMMARY OF THE INVENTION

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

The invention was made in view of the deficiencies of the prior art and provides systems, methods and processes for overcoming these deficiencies. N95 respirators and surgical protection masks are available and used globally; however, neither N95 respirators nor surgical masks effectively protect the wearer against viruses. N95 respirators nor surgical masks are important to prevent large particles and droplets from being emitted to the environment by a contagious person, but the wearer is not protected. Air easily penetrates the surgical mask around its perimeter during inhalation.

N95 respirators, when professionally fitted, are better but yet not perfectly sealed. N95 respirators are 95% efficient to block particles that are greater than 0.3 micron, but as particles size gets smaller many more particles do penetrate. This means N95 respirators are 95% effective against bacteria which are sized greater than 0.3 micron, but not against viruses. The size of the Corona virus is approximately 0.1 micron.

Therefore, the prevailing masks and respirators are deficient as they allow 5% of air to penetrate and the presumably filtered air is not cleared of its viral load. Accordingly, providing a respiratory device that is effectively protects against virial biohazards is clearly an acutely needed solution to a grave problem.

According to some embodiments and aspects, it is an objective of the present invention to provide a multipurpose protective respiratory headgear, with anteriorly mounted exchangeable cartridge, effective inter alia against viral biohazards.

According to some embodiments and aspects, it is an objective of the present invention to provide a multipurpose protective respiratory headgear, with anteriorly mounted exchangeable cartridge, effective inter alia against chemical hazards and contaminated or polluted environment.

According to some embodiments and aspects, it is an objective of the present invention to provide a multipurpose protective respiratory headgear, with anteriorly mounted exchangeable cartridge, effective inter alia in protecting the exterior environment, from biological contamination by the user.

In accordance with some embodiments and aspects of the present invention, there is provided a new class of a protective respiratory headgear, which filters out more than 99.97% of viruses and other particles greater than 0.1 micron, when actually used by any person. The term “actually used” means that the protective factor is to be achieved when the protective respiratory headgear is donned by a person, based not just on the generic filter characteristics, when the person is wearing it at rest or performing work. By “any person” means people of all races and ethnicities, both genders and all age groups. “Any person” further means people with deformed faces and people who suffer from lung or other diseases which preclude them from breathing through increased resistance.

According to some embodiments and aspects, it is an objective of the present invention for the protective respiratory headgear to meet existing criteria as well as certain parameters and new test protocols, safety criteria (i.e. resistance to flow and CO2 build-up), comfort, durability and cleaning/disinfection criteria as well as meet available standards and directives of CE (EU), FDA; NIOSH (USA), Shonin (Japan), CFDA (China), Anvisa (Brazil), AMAR (Israel) and TGA (Australia), including the relevant Quality Systems. These standards include performance standards, safety standards and biocompatibility standards.

According to some embodiments and aspects, it is an objective of the present invention to provide the contribution of using the new protective respiratory headgear to prevention of spread of Corona viruses in general and particularly 2019-nCoV, in virus-loaded environments.

According to some embodiments and aspects, it is an objective of the present invention to provide a new protective respiratory headgear characterized by superb adjoining of the headgear to the facial surface of the user, thereby achieving tight sealing of the airways of the user.

According to some embodiments and aspects, it is an objective of the present invention to provide a new protective respiratory headgear characterized by superb stability of the anteriorly mounted exchangeable filter cartridge, within the cartridge receiving portion of the protective respiratory headgear.

According to some embodiments and aspects, it is an objective of the present invention to provide a new protective respiratory headgear characterized by the ease of installing and using protective respiratory headgear, as well as by the ease of mounting and replacing anteriorly mounted exchangeable filter cartridge.

According to some embodiments and aspects, it is an objective of the present invention to provide a new protective respiratory headgear characterized by unique orientational compatibility between the anteriorly mounted exchangeable filter cartridge and the protective respiratory headgear.

In accordance with some aspects and embodiments of the present invention, a protective respiratory system is provided including: a multipurpose protective respiratory headgear includes: a superior portion, configured to fit tightly against an upper facial surface of a subject, including: a vizor portion, including a transparent material, configured to adjoin the facial surface around ocular regions of the subject; at least one tab, configured to anchor an elastic strap; a nasolabial portion, configured to adjoin a lower facial surface around nasal and labial regions of the subject, the nasolabial portion including: an essentially triangular extrusion shape; an essentially rectangular horizontal recess, configured to receive an exchangeable filter cartridge; an anteriorly mounted exchangeable filter cartridge, an essentially rectangular paralepidid shaped shell; an essentially rectangular anterior removable lid; a replaceable filter medium; a structured posterior outlet aperture; the system is characterized by that: the nasolabial portion of the protective respiratory headgear defines an essentially trapezoid shaped inlet aperture; the anteriorly mounted exchangeable filter cartridge includes an essentially trapezoid shaped posteriorly extending ridge, essentially surrounding the structured posterior outlet aperture; in which the essentially trapezoid shaped inlet aperture in the nasolabial portion of the protective respiratory headgear is configured to conform to essentially trapezoid shaped posteriorly extending ridge on the anteriorly mounted exchangeable filter cartridge.

In some embodiments a protective respiratory system is provided, in which the transparent material of the vizor portion is selected from the group consisting of: glass and polycarbonate.

In some embodiments a protective respiratory system is provided, in which the vizor portion of the superior portion of the multipurpose protective respiratory headgear further includes a coating selected from the group: anti-UV coating, antiglare coating, reflective coating and semi-reflective coating.

In some embodiments a protective respiratory system is provided, in which the superior portion includes three tabs, in which one tab is disposed in a central portion and two tabs are disposed in side portions of the superior portion of the multipurpose protective respiratory headgear.

In some embodiments a protective respiratory system is provided, in which the essentially trapezoid shaped inlet aperture in the protective respiratory headgear is formed at the intersection the essentially triangular exteriorly extending extrusion of the nasolabial portion and rectangular horizontal recess in the nasolabial portion.

In some embodiments a protective respiratory system is provided, in which an inferior protrusion is formed at a bottom of the essentially rectangular horizontal recess, of the nasolabial portion of the protective respiratory headgear.

In some embodiments a protective respiratory system is provided, in which the anteriorly mounted exchangeable filter cartridge is mountable symmetrically about a vertical cross-sectional plane of the multipurpose protective respiratory headgear.

In some embodiments a protective respiratory system is provided, in which the replaceable filter medium of the anteriorly mounted exchangeable filter cartridge is fillable in the essentially rectangular paralepidid shaped shell.

In some embodiments a protective respiratory system is provided, in which the essentially rectangular paralepidid shaped shell includes a plurality of anteriorly facing spacers disposed on an interior side of a posterior face of the rectangular paralepidid shaped shell.

In some embodiments a protective respiratory system is provided, in which the anteriorly mounted exchangeable filter cartridge is affixable into the essentially rectangular horizontal recess of the multipurpose protective respiratory headgear, by an upper clip.

In accordance with some aspects and embodiments of the present invention, an anteriorly mountable exchangeable filter cartridge, for a multipurpose protective respiratory headgear, is provided including: an essentially rectangular paralepidid shaped shell; an essentially rectangular anterior removable lid; a replaceable filter medium; a structured posterior outlet aperture; an essentially trapezoid shaped posteriorly extending ridge, essentially surrounding the structured posterior outlet aperture; the multipurpose protective respiratory headgear is characterized by that: the nasolabial portion of the protective respiratory headgear defines an essentially trapezoid shaped inlet aperture; the essentially trapezoid shaped posteriorly extending ridge, essentially surrounding the structured posterior outlet aperture; in which the essentially trapezoid shaped inlet aperture in the nasolabial portion of the protective respiratory headgear is configured to conform to essentially trapezoid shaped posteriorly extending ridge on the anteriorly mounted exchangeable filter cartridge.

In some embodiments a cartridge is provided, in which the essentially trapezoid shaped inlet aperture in the protective respiratory headgear is formed at the intersection the essentially triangular exteriorly extending extrusion of the nasolabial portion and rectangular horizontal recess in the nasolabial portion.

In some embodiments a cartridge is provided, in which an inferior protrusion is formed at a bottom of the essentially rectangular horizontal recess, of the nasolabial portion of the protective respiratory headgear.

In some embodiments a cartridge is provided, in which the anteriorly mounted exchangeable filter cartridge is mountable symmetrically about a vertical cross-sectional plane of the multipurpose protective respiratory headgear.

In some embodiments a cartridge is provided, in which the replaceable filter medium of the anteriorly mounted exchangeable filter cartridge is fillable in the essentially rectangular paralepidid shaped shell.

In some embodiments a cartridge is provided, in which the essentially rectangular paralepidid shaped shell includes a plurality of anteriorly facing spacers disposed on an interior side of a posterior face of the rectangular paralepidid shaped shell.

In some embodiments a cartridge is provided, in which the anteriorly mounted exchangeable filter cartridge is affixable into the essentially rectangular horizontal recess of the multipurpose protective respiratory headgear, by an upper clip.

In accordance with some aspects and embodiments of the present invention, a method of using a multipurpose protective respiratory headgear, with anteriorly mounted exchangeable cartridge, is provided including: providing a multipurpose protective respiratory headgear includes: a superior portion, configured to fit tightly against an upper facial surface of a subject, including: a vizor portion, including a transparent material, configured to adjoin the facial surface around ocular regions of the subject; at least one tab, configured to anchor an elastic strap; a nasolabial portion, configured to adjoin a lower facial surface around nasal and labial regions of the subject, the nasolabial portion including: an essentially triangular extrusion shape; an essentially rectangular horizontal recess, configured to receive an exchangeable filter cartridge; an essentially trapezoid shaped inlet aperture; providing an anteriorly mounted exchangeable filter cartridge, an essentially rectangular paralepidid shaped shell; an essentially rectangular anterior removable lid; a replaceable filter medium; a structured posterior outlet aperture; an essentially trapezoid shaped posteriorly extending ridge, essentially surrounding the structured posterior outlet aperture; inserting the anteriorly mounted exchangeable filter cartridge into the essentially rectangular horizontal recess of the nasolabial portion of the protective respiratory headgear; in which the inserting of the anteriorly mounted exchangeable filter cartridge into the essentially rectangular horizontal recess of the nasolabial portion of the protective respiratory headgear includes inserting the essentially trapezoid shaped inlet aperture in the nasolabial portion of the protective respiratory headgear into the essentially trapezoid shaped posteriorly extending ridge on the anteriorly mounted exchangeable filter cartridge; releasing the anteriorly mounted exchangeable filter cartridge from the essentially rectangular horizontal recess in the nasolabial portion of the multipurpose protective respiratory headgear.

In some embodiments a method is provided including: providing a multipurpose protective respiratory headgear includes: a superior, in which the anteriorly mounted exchangeable filter cartridge is affixable into the essentially rectangular horizontal recess of the multipurpose protective respiratory headgear, by an upper clip, in which the inserting further includes appending a bottom portion of the cartridge to a bottom portion of the essentially triangular extrusion and swiveling a top portion of the cartridge in a direction towards a top portion of the essentially triangular extrusion.

### Definitions

The term NIOSH is to be construed as referring to the publications of National Institute for Occupational Safety and Health (NIOSH) of the US government air filtration rating regulations, pertaining to respirators and masks worn to filter contaminated air. NIOSH is different in some aspects from the FFP2 and FFP3 classifications according to European standard EN 143. NIOSH ratings include the first part of the filter's classification, marked by letters N, R, or P to indicate the filter's ability to function when exposed to petroleum, where “N”=not resistant to petroleum, “R”=somewhat resistant to petroleum and “P”=strongly resistant to petroleum, whereas the second part lists the percentage of particles that the mask is certified to block, such as 95, 97 or 99 percent of airborne particles.

The terms pliable or pliant, as referred to herein, are to be construed as having relatively high tensile strength and capable of being efficiently elastically flexed or bent but not being resilient and incapable of being efficiently stretched or expanded. The term tensile or tensile strength, as referred to herein, is to be construed inter alia as a shortcut of the known term ultimate tensile strength, frequently represented acronym as UTS, meaning an intensive property of a material or structure to withstand loads tending to elongate, namely to resist tension, defined as the maximum stress that a material can withstand while been stretched or pulled before sustaining breaking, substantial deformation and/or necking before fracture, such as nylon, relating to essentially non-ductile materials.

The terms elastic or resilient, as referred to herein, are to be construed as having tensile strength lower than aforesaid tensile strength of pliable or pliant material and optionally being capable of efficiently stretching or expanding, relating inter alia to essentially ductile materials.

The term “Shore” refers to a measure of hardness of material using a durometer, e.g., similar to that described in U.S. Pat. No. 1,770,045 to Shore et al. The term “Shore A” refers to aforesaid measure of hardness of material using a type A Shore durometer.

The terms matching and/or matchable and/or close fit and/or following the contour as referred to herein is to be construed as effectively adjoining.

The term structured as referred to herein is to be construed as including any geometrical shape, exceeding in complexity a plain geometrical shape or a shape embodying simple cylindrical, elliptical or polygonal contour or profile. A more complex shape, a non-linear shape or a shape combining simple cylindrical, elliptical or polygonal contour or profile, constitutes an example of structured geometry.

The term modular or exchangeable, as referred to herein, should be construed as removably connectable. The term modular or exchangeable inter alia means a standardized unit that may be conveniently installed or deployed without significant impact on other components. The term exchangeable typically provides for ease of interchange or replacement. The term modular or exchangeable is optionally satisfied by providing for ease of at least deployment or installation.

By “operationally connected” and “operably coupled”, as used herein, is meant connected in a specific way that allows the disclosed system and its various components to operate effectively in the manner described herein.

The term “substantially” as used herein is a broad term, and is to be given its ordinary and customary meaning to a person of ordinary skill in the art (and is not to be limited to a special or customized meaning), and refers without limitation to being largely but not necessarily entirely of that quantity or quality which is specified.

The term “essentially” means that the composition, method or structure may include additional ingredients, stages and or parts, but only if the additional ingredients, the stages and/or the parts do not materially alter the basic and new characteristics of the composition, method or structure claimed.

As used herein, the term “essentially” changes a specific meaning, meaning an interval of plus or minus ten percent (±10%). For any embodiments disclosed herein, any disclosure of a particular value, in some alternative embodiments, is to be understood as disclosing an interval approximately or about equal to that particular value (i.e., ±10%).

As used herein, the terms “about” or “approximately” modify a particular value, by referring to a range equal to the particular value, plus or minus twenty percent (+1-20%). For any of the embodiments, disclosed herein, any disclosure of a particular value, can, in various alternate embodiments, also be understood as a disclosure of a range equal to about that particular value (i.e. +/−20%).

Whenever in the specification hereunder and particularly in the claims appended hereto a verb, whether in base form or any tense, a gerund or present participle or a past participle are used, such terms as well as preferably other terms are to be construed as actual or constructive, meaning inter alia as being merely optionally or potentially performed and/or being only performed anytime in future. The terms essentially and substantially, or similar relative terms, are to be construed in accordance with their ordinary dictionary meaning, namely mostly but not completely.

As used herein, the term “or” is an inclusive “or” operator, equivalent to the term “and/or,” unless the context clearly dictates otherwise; whereas the term “and” as used herein is also the alternative operator equivalent to the term “and/or,” unless the context clearly dictates otherwise.

It should be understood, however, that neither the briefly synopsized summary nor particular definitions hereinabove are not to limit interpretation of the invention to the specific forms and examples but rather on the contrary are to cover all modifications, equivalents and alternatives falling within the scope of the invention.

### DESCRIPTION OF THE DRAWINGS

The present invention will be understood and appreciated more comprehensively from the following detailed description taken in conjunction with the appended drawings in which:

FIG. 1A is a perspective schematic view of a subject wearing respirator known in the art as N95;

FIG. 1B is a schematic frontal view of a subject wearing a typical prior art surgical mask;

FIG. 2A is an isometric view of an embodiment of the protective respiratory headgear of the invention;

FIG. 2B is a frontal view of an embodiment of the protective respiratory headgear of the invention;

FIG. 2C is a posterior perspective view of an embodiment of the protective respiratory headgear of the invention;

FIG. 2D is a back view of an embodiment of the protective respiratory headgear of the invention;

FIG. 2E is a side view of an embodiment of the protective respiratory headgear of the invention;

FIG. 2F is a top view of an embodiment of the protective respiratory headgear of the invention;

FIG. 3A is a posterior perspective view of an embodiment of the anteriorly mounted exchangeable filter cartridge, of the protective respiratory headgear of the invention;

FIG. 3B is an isometric view of an embodiment of the anteriorly mounted exchangeable filter cartridge, of the protective respiratory headgear of the invention;

FIG. 3C is a side view of an embodiment of the anteriorly mounted exchangeable filter cartridge, of the protective respiratory headgear of the invention;

FIG. 3D is a back view of an embodiment of the anteriorly mounted exchangeable filter cartridge, of the protective respiratory headgear of the invention;

FIG. 3E is a top view of an embodiment of the anteriorly mounted exchangeable filter cartridge, of the protective respiratory headgear of the invention;

FIG. 3F is a frontal view of an embodiment of the anteriorly mounted exchangeable filter cartridge, of the protective respiratory headgear of the invention;

FIG. 4A is an isometric view of an embodiment of the assembly of the protective respiratory headgear and the anteriorly mounted exchangeable filter cartridge of the invention;

FIG. 4B is a frontal view of an embodiment of the assembly of the protective respiratory headgear and the anteriorly mounted exchangeable filter cartridge of the invention;

FIG. 4C is an inferior perspective view of an embodiment of the assembly of the protective respiratory headgear and the anteriorly mounted exchangeable filter cartridge of the invention;

FIG. 4D is a side view of an embodiment of the assembly of the protective respiratory headgear and the anteriorly mounted exchangeable filter cartridge of the invention;

FIG. 4E is a top view of an embodiment of the assembly of the protective respiratory headgear and the anteriorly mounted exchangeable filter cartridge of the invention;

FIG. 4F is a back view of an embodiment of the assembly of the protective respiratory headgear and the anteriorly mounted exchangeable filter cartridge of the invention;

FIG. 4G is a cross-sectional view of an embodiment of the assembly of the protective respiratory headgear and the anteriorly mounted exchangeable filter cartridge of the invention, wherein the cross-section is taken along the section line G-G, shown in FIG. 4F.

While the invention is susceptible to various modifications and alternative forms, specific embodiments thereof have been shown merely by way of example in the drawings. The drawings are not necessarily complete and components are not essentially to scale; emphasis instead being placed upon clearly illustrating the principles underlying the present invention.

### DETAILED DISCLOSURE OF EMBODIMENTS

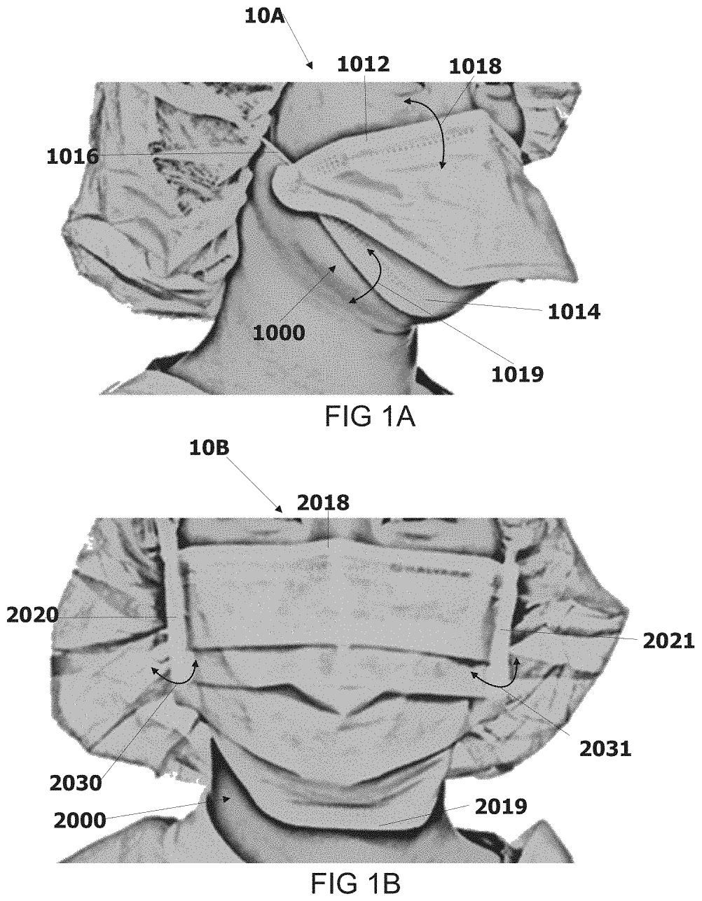

Prior to elaborating any embodiment of the present invention, in order to present the background for the inventive concept more clearly, reference is firstly made to FIGS. 1A and 1B, respectively, showing respirator 1000 known in the art as N95 and typical prior art surgical mask 2000. Typical surgical mask 2000, shown in FIG. 1B, also known as a procedure mask or medical mask, is primarily intended to be worn by health professionals during surgery and during nursing, to catch the bacteria in liquid droplets and aerosols from the wearer's mouth and nose and protect the wearer against splashes of large drops or sprays of biological fluids such as blood, puss, urine and other body fluids during procedure. Typical surgical mask 2000 is not designed to provide ultimate protection to the wearer from inhaling airborne bacteria or virus in small particles or aerosols and are less effective than respirators, such as N95 respirators, which provide better protection due to their material, shape and tighter seal.

N95 respirator 1000, shown in FIG. 1A, which a common type respirator carrying a NIOSH rating, is as aforementioned recommended by the US Centers for Disease Control and Prevention (CDC) for most cases of air contamination. N95 filters are designed to seal more tightly around mouth and nose and are certified to block 95% of particulate matter sized 0.3 micron or larger in diameter. N95 respirator are insufficient to stop most dry individual viruses, which typically range from 0.04 to 0.3 micron in diameter, however viruses that only survive in droplet of watery fluid (e.g., sputum), may be blocked if the fit is optimal. N95 respirator are however further known for relative difficulty to breathe through and their full effectiveness also critically depends on a good fit.

It is much harder to breathe through N95 respirator 1000, than it is through surgical mask 2000, because the air has to pass through the filter in N95 respirator 1000, instead of coming in through the filter and around the margins in surgical mask 2000. NIOSH recommends set forth for respirator 1000 that each respirator wearer should receive an initial fit test and annual fit tests thereafter. Those NIOSH recommends considered equivalent to recommends European FFP2, China KN95, AS/NZ P2, Korea 1st Class, and Japan DS.

Referring particularly to FIG. 1A, N95 respirator 1000 is disposed on the face of subject 10A. Respirator 1000 comprises upper seal 1012 and lower seal 1014 that are supposed to seal respectively above the nose area the and underneath the jaw. Respirator 1000 further comprises strap 1016, extending from side to side behind the head of subject 10A, optimally is configured to seal and secure N95 respirator 1000 on the face of subject 10A. However, with different kind of facial features, openings for air may occur. Arrows 1018 and arrows 1019 show the gaps where air can typically get around respirator 1000.

Referring particularly to FIG. 1B, surgical mask 2000 is disposed on the face of subject 10B. Mask 2000 comprises upper member 2018 and lower member 2019, which are configured to keep surgical mask 2000 sprawled. Mask 2000 is held on the face of subject 10B by a means of strap 2020 and strap 2021. Because surgical mask 2000 is designed to keep fluids and air from the user to spread to enter from the environment, there are purposefully formed air outlets on the sides. The air outlets on the sides are indicated by arrows 2030 and arrows 2031, showing the area where air can get in and out freely from the environment.

Illustrative embodiments of the invention are described below. In the interest of clarity, not all features of actual implementation are described in this specification. It should be appreciated that various features or elements described in the context of some embodiments may be interchangeable with features or elements of any other embodiment described in the specification. Moreover, it will be appreciated that for the development of any actual embodiment, numerous implementation-specific decisions must be made to achieve the developers' specific goals, such as compliance with technology- or business-related constraints, which may vary from one implementation to another, and the effort of such a development might be complex and time-consuming, but would nevertheless be a routine undertaking for those of ordinary skill in the art having the benefit of this disclosure.

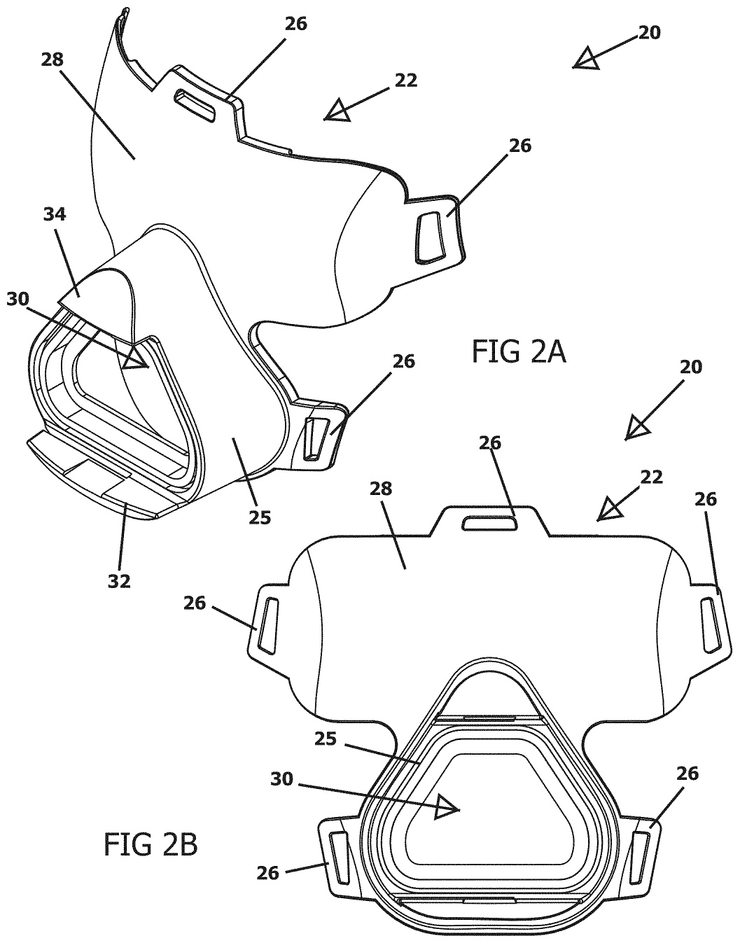

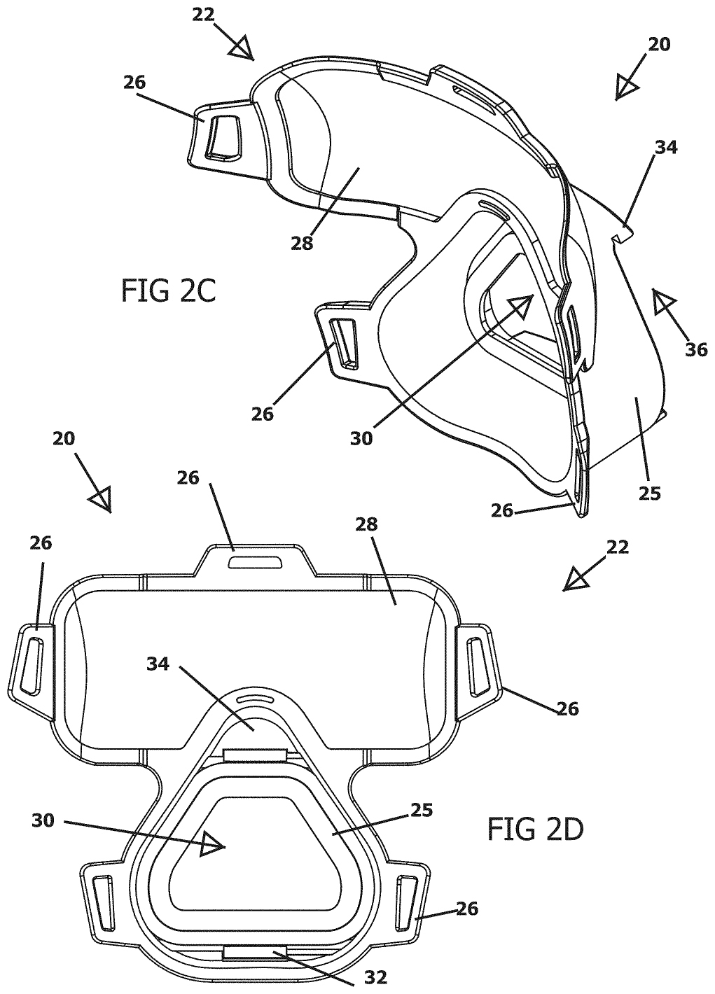

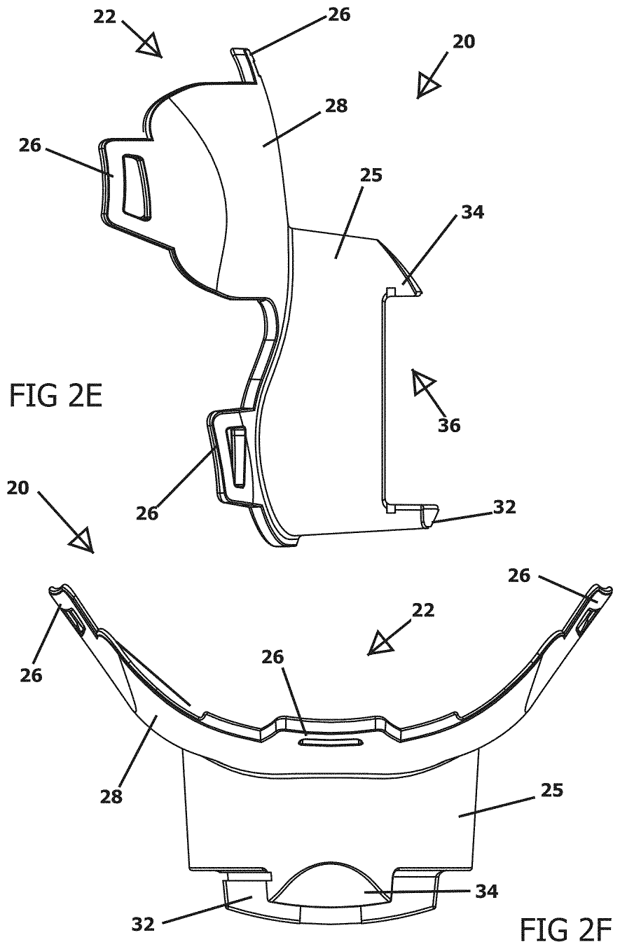

In accordance with some embodiments of the present invention, reference is now made to FIG. 2A to 2F showing respectively an isometric, frontal, posterior perspective, back, side and top views of multipurpose protective respiratory headgear 20, with anteriorly mounted exchangeable cartridge (not shown), effective inter alia for protection against chemical hazards as well as contaminated and/or polluted environments. Multipurpose protective respiratory headgear 20 comprises superior portion 22 configured to fit tightly against an upper facial surface of a subject (not shown) and nasolabial portion 25, configured to adjoin a lower facial surface around nasal and labial regions of said subject.

Superior portion 22 of multipurpose protective respiratory headgear 20 comprises vizor 28, configured to adjoin said facial surface around ocular regions of said subject. Vizor 28 comprises a clear transparent material, for example glass or polycarbonate, configured for sealing the eyes of the subject from the environment, while facilitating seeing by the subject throughout. Vizor 28 is optionally coated with an anti-UV, antiglare, reflective or semi-reflective coating.

Superior portion 22 of multipurpose protective respiratory headgear 20 comprises at least one tab or preferably a plurality of tabs 26. Preferably there three tabs 26, namely one on top and two on the sides of superior portion 22 of multipurpose protective respiratory headgear 20. Preferably there three tabs 26 are used respectively for an over-the-head strap (not shown) and for a circumferential strap (not shown), thereby conferring superb stability on and tight adjoining to the facial surface of a subject (not shown).

Nasolabial portion 25, configured to adjoin a lower facial surface around nasal and labial regions of the user, preferably embodies an essentially triangular anteriorly extending extrusion shell shape, chamfered along the longitudinal edges of the extrusion. The essentially triangular anteriorly extending extrusion shell shape of nasolabial portion 25 comprises an essentially rectangular horizontal recess 36, configured to receive an exchangeable filter cartridge (not shown).

In some preferred embodiments, nasolabial portion 25 of protective respiratory headgear 20 defines an essentially trapezoid shaped inlet aperture 30. Essentially trapezoid shaped inlet aperture 30 in protective respiratory headgear 20 is preferably formed at the intersection of essentially rectangular horizontal recess 36, configured to receive an exchangeable filter cartridge (not shown), and essentially triangular anteriorly extending extrusion shell shape of nasolabial portion 25.

In some preferred embodiments, above the intersection of essentially rectangular horizontal recess 36, configured to receive an exchangeable filter cartridge (not shown), nasolabial portion 25 of protective respiratory headgear 20 comprises superior protrusion 34. In some preferred embodiments, beneath the intersection of essentially rectangular horizontal recess 36, configured to receive an exchangeable filter cartridge (not shown), nasolabial portion 25 of protective respiratory headgear 20 comprises inferior protrusion 32. Superior protrusion 34 in nasolabial portion 25 above the intersection of essentially rectangular horizontal recess 36 and inferior protrusion 32 beneath the intersection of essentially rectangular horizontal recess 36 are configured to facilitate the ease of exchangeability of a matching anteriorly mounted exchangeable filter cartridge (not shown), as will be elaborated infra.

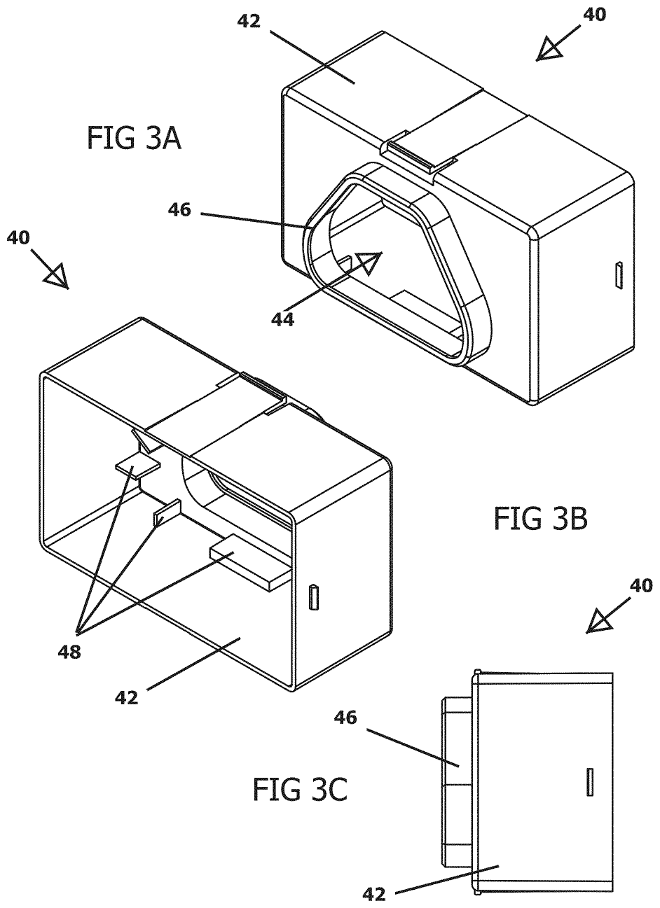

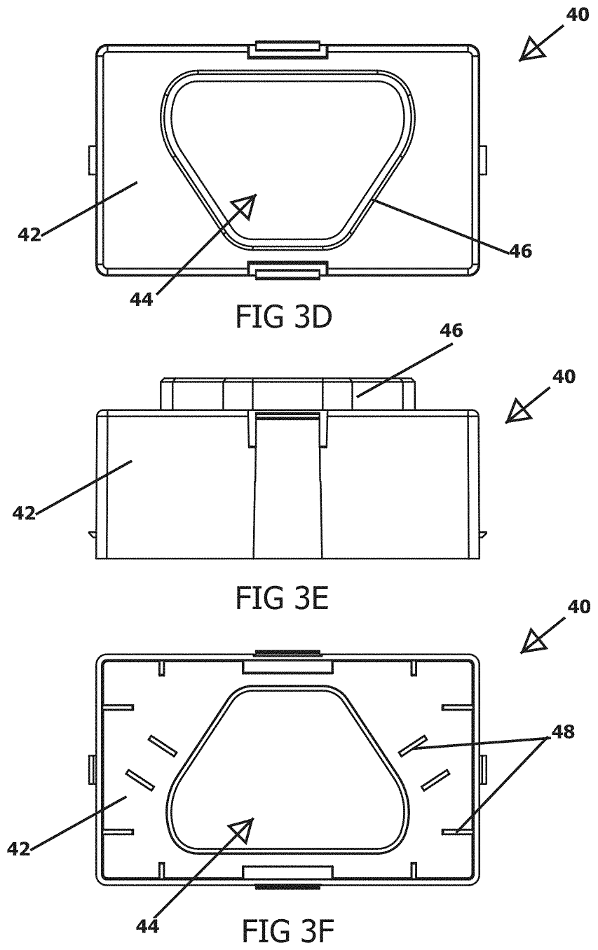

In accordance with some embodiments of the present invention, reference is now made to FIG. 3A to 3F showing respectively a posterior perspective, isometric, side, back, top and frontal views of anteriorly mounted exchangeable filter cartridge 40, matching multipurpose protective respiratory headgear 20, shown in FIG. 2A to 2F. Exchangeable filter cartridge 40, shown in FIG. 3A to 3F, is mounted anteriorly and not sidewise, as opposed to respirators known in the art.

Exchangeable filter cartridge 40 is preferably mounted symmetrically along the vertical correctional plane, of multipurpose protective respiratory headgear 20, shown in FIG. 2A to 2F, as opposed to respirators known in the art. Anteriorly mounted filter cartridge 40, shown in FIG. 3A to 3F, is further easily exchangeable, as will be elaborated infra.

Anteriorly mounted exchangeable filter cartridge 40 embodies essentially rectangular paralepidid shaped shell 42. Anteriorly mounted exchangeable filter cartridge 40 comprises an essentially rectangular matching removable anterior lid (not shown). Anteriorly mounted exchangeable filter cartridge 40 is preferably reusable and configured to contain a replaceable filter medium (not shown). The replaceable filter medium (not shown) is finable in essentially rectangular paralepidid shaped shell 42 according to the application of multipurpose protective respiratory headgear 20, shown in FIG. 2A to 2F. For instance, to achieve protection against biohazards, essentially rectangular paralepidid shaped shell 42 is optionally filled with HEPA membranes, natrium chloride or bleaching agent, such as potassium permanganate; whereas to achieve protection against chemical pollutants, essentially rectangular paralepidid shaped shell 42 is optionally filled with activated carbon.

Anteriorly mounted exchangeable filter cartridge 40 comprises structured posterior outlet aperture 44. In some preferred embodiments, structured posterior outlet aperture 44 embodies an essentially trapezoid shape. In some preferred embodiments, rectangular paralepidid shaped shell 42 comprises posteriorly extending ridge 46. In some preferred embodiments, posteriorly extending ridge 46 embodies an essentially trapezoid shape. Essentially trapezoid shaped posteriorly extending ridge 46 preferably surrounds structured posterior outlet aperture 44.

In some preferred embodiments, essentially rectangular paralepidid shaped shell 42 comprises a plurality of spacers 48. Spacers 48 typically are disposed on the interior side of posterior face of essentially rectangular paralepidid shaped shell 42 and face anteriorly. Spacers 48 are configured to facilitate efficient circulation of gas or air in-between posterior face of essentially rectangular paralepidid shaped shell 42 and the back face of a replaceable filter medium (not shown).

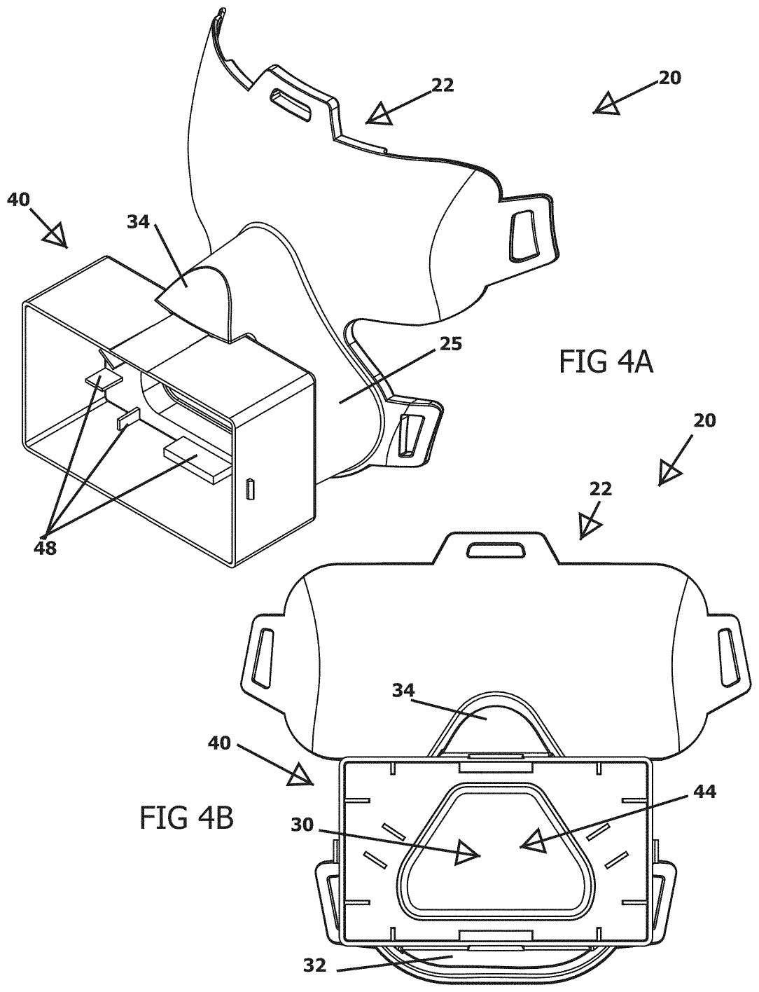

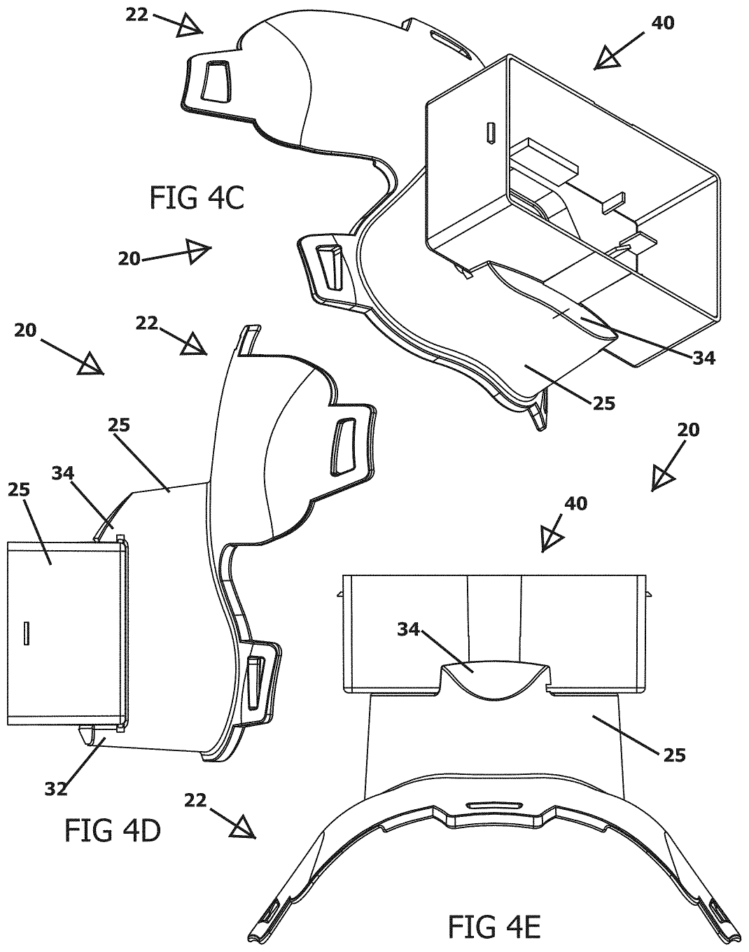

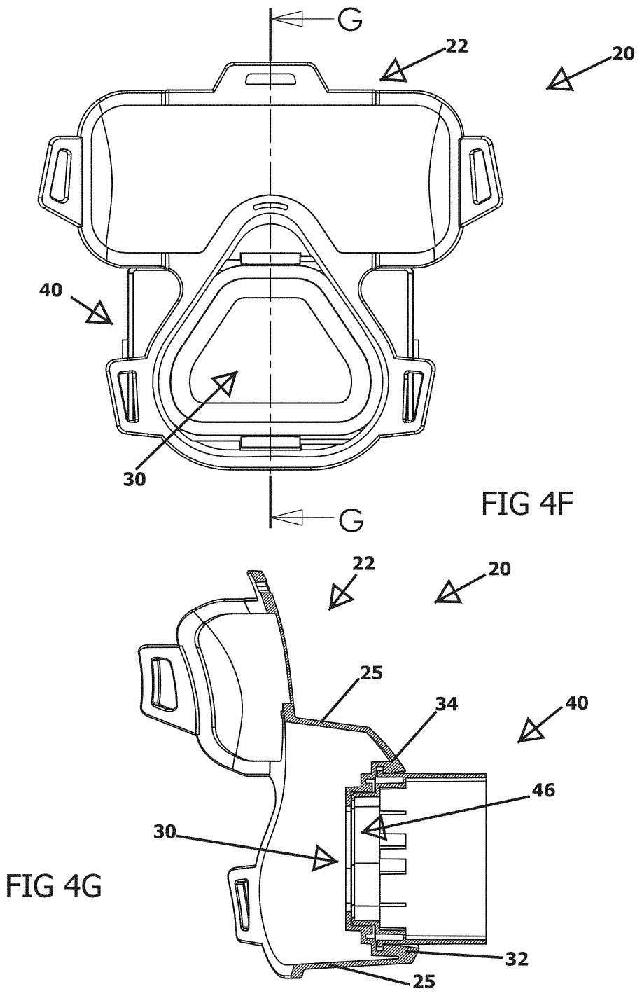

In accordance with some embodiments of the present invention, reference is now made to FIG. 4A to 4G showing respectively an isometric, frontal, inferior perspective, side, top, back and cross-sectional views of an embodiment of an assembly of multipurpose protective respiratory headgear 20, shown in FIG. 2A to 2F, and anteriorly mounted exchangeable filter cartridge 40, shown in FIG. 3A to 3F, elaborating some details of a preferable attachment mechanism of anteriorly mounted exchangeable filter cartridge 40 to multipurpose protective respiratory headgear 20. In some preferred embodiments, posteriorly extending trapezoid shaped ridge 46 on anteriorly mounted exchangeable filter cartridge 40 is configured to conform to essentially trapezoid shaped inlet aperture 30 in nasolabial portion 25 of protective respiratory headgear 20.

Anteriorly mounted exchangeable filter cartridge 40 is mounted into essentially rectangular horizontal recess 36 of multipurpose protective respiratory headgear 20, in-between superior protrusion 34 in nasolabial portion 25 and inferior protrusion 32 of nasolabial portion 25. Anteriorly mounted exchangeable filter cartridge 40 is typically mounted into essentially rectangular horizontal recess 36 of multipurpose protective respiratory headgear 20, by initially appending a downwardly facing tipping ridge, which is preferably disposed on a leaf-spring appendage on the bottom face of essentially rectangular paralepidid shaped shell 42 of anteriorly mounted exchangeable filter cartridge 40, into an upwardly facing matching groove, in inferior protrusion 32 of nasolabial portion 25.

Anteriorly mounted exchangeable filter cartridge 40 is typically fastened within essentially rectangular horizontal recess 36 of multipurpose protective respiratory headgear 20, by rotating anteriorly mounted exchangeable filter cartridge 40 upwards and towards superior protrusion 34 in nasolabial portion 25, while the downwardly facing tipping ridge is within the upwardly facing matching groove in inferior protrusion 32 of nasolabial portion 25.

Anteriorly mounted exchangeable filter cartridge 40 is typically secured within essentially rectangular horizontal recess 36 of multipurpose protective respiratory headgear 20, by inserting an upwardly facing tipping ridge, which is preferably disposed on a leaf-spring appendage on the top face of essentially rectangular paralepidid shaped shell 42 of anteriorly mounted exchangeable filter cartridge 40, into an downwardly facing matching groove, in superior protrusion 34 of nasolabial portion 25. The inserting of the upwardly facing tipping ridge, into a downwardly facing matching groove, in superior protrusion 34 of nasolabial portion 25, is preferably performed by snapping in the upwardly facing tipping ridge on a leaf-spring appendage on the top face of essentially rectangular paralepidid shaped shell 42 of anteriorly mounted exchangeable filter cartridge 40, in superior protrusion 34 of nasolabial portion 25.

Releasing of anteriorly mounted exchangeable filter cartridge 40 from essentially rectangular horizontal recess 36 in nasolabial portion 25 of multipurpose protective respiratory headgear 20 is typically performed by releasing the upwardly facing tipping ridge, on the top face of essentially rectangular paralepidid shaped shell 42 of anteriorly mounted exchangeable filter cartridge 40, from the downwardly facing matching groove, in superior protrusion 34 of nasolabial portion 25, which is preferably performed by pressing down onto the leaf-spring appendage on the top face of essentially rectangular paralepidid shaped shell 42 of anteriorly mounted exchangeable filter cartridge 40.

It will be appreciated by persons skilled in the art that the present invention is not limited by what has been particularly shown and described herein above. Rather the scope of the invention is defined by the claims which follow:

1. A protective respiratory system:
(a) a multipurpose protective respiratory headgear comprises:
(I) a superior portion, configured to fit tightly against an upper facial surface of a subject, comprising:
(i) a vizor portion, comprising a transparent material, configured to adjoin said facial surface around ocular regions of said subject;
at least one tab, configured to anchor an elastic strap;
(II) a nasolabial portion, configured to adjoin a lower facial surface around nasal and labial regions of said subject, said nasolabial portion comprising:
(i) an essentially triangular extrusion shape;
(ii) an essentially rectangular horizontal recess, configured to receive an exchangeable filter cartridge;
(b) an anteriorly mounted exchangeable filter cartridge,
(I) an essentially rectangular paralepidid shaped shell;
(II) an essentially rectangular anterior removable lid;
(III) a replaceable filter medium;
(IV) a structured posterior outlet aperture;
said system is characterized by that:
(i) said nasolabial portion of said protective respiratory headgear defines an essentially trapezoid shaped inlet aperture;
(ii) said anteriorly mounted exchangeable filter cartridge comprises an essentially trapezoid shaped posteriorly extending ridge, essentially surrounding said structured posterior outlet aperture;
(iii) wherein said essentially trapezoid shaped inlet aperture in said nasolabial portion of said protective respiratory headgear is configured to conform to essentially trapezoid shaped posteriorly extending ridge on said anteriorly mounted exchangeable filter cartridge.

2. The system as in claim 1, wherein said transparent material of said vizor portion is selected from the group consisting of: glass and polycarbonate.

3. The system as in claim 1, wherein said vizor portion of said superior portion of said multipurpose protective respiratory headgear further comprises a coating selected from the group: anti-UV coating, antiglare coating, reflective coating and semi-reflective coating.

4. The system as in claim 1, wherein said superior portion comprises three tabs, wherein one tab is disposed in a central portion and two tabs are disposed in side portions of said superior portion of said multipurpose protective respiratory headgear.

5. The system as in claim 1, wherein said essentially trapezoid shaped inlet aperture in said protective respiratory headgear is formed at the intersection said essentially triangular exteriorly extending extrusion of said nasolabial portion and rectangular horizontal recess in said nasolabial portion.

6. The system as in claim 1, wherein an inferior protrusion is formed at a bottom of said essentially rectangular horizontal recess, of said nasolabial portion of said protective respiratory headgear.

7. The system as in claim 1, wherein said anteriorly mounted exchangeable filter cartridge is mountable symmetrically about a vertical cross-sectional plane of said multipurpose protective respiratory headgear.

8. The system as in claim 1, wherein said replaceable filter medium of said anteriorly mounted exchangeable filter cartridge is fillable in said essentially rectangular paralepidid shaped shell.

9. The system as in claim 1, wherein said essentially rectangular paralepidid shaped shell comprises a plurality of anteriorly facing spacers disposed on an interior side of a posterior face of said rectangular paralepidid shaped shell.

10. The system as in claim 1, wherein said anteriorly mounted exchangeable filter cartridge is affixable into said essentially rectangular horizontal recess of said multipurpose protective respiratory headgear, by an upper clip.

11. An anteriorly mountable exchangeable filter cartridge, for a multipurpose protective respiratory headgear, comprises:
(I) an essentially rectangular paralepidid shaped shell;
(II) an essentially rectangular anterior removable lid;
(III) a replaceable filter medium;
(IV) a structured posterior outlet aperture;
(V) an essentially trapezoid shaped posteriorly extending ridge, essentially surrounding said structured posterior outlet aperture;
said multipurpose protective respiratory headgear is characterized by that:
(i) said nasolabial portion of said protective respiratory headgear defines an essentially trapezoid shaped inlet aperture;
(ii) said essentially trapezoid shaped posteriorly extending ridge, essentially surrounding said structured posterior outlet aperture;
wherein said essentially trapezoid shaped inlet aperture in said nasolabial portion of said protective respiratory headgear is configured to conform to essentially trapezoid shaped posteriorly extending ridge on said anteriorly mounted exchangeable filter cartridge.

12. The cartridge as in claim 11, wherein said essentially trapezoid shaped inlet aperture in said protective respiratory headgear is formed at the intersection said essentially triangular exteriorly extending extrusion of said nasolabial portion and rectangular horizontal recess in said nasolabial portion.

13. The cartridge as in claim 11, wherein an inferior protrusion is formed at a bottom of said essentially rectangular horizontal recess, of said nasolabial portion of said protective respiratory headgear.

14. The cartridge as in claim 11, wherein said anteriorly mounted exchangeable filter cartridge is mountable symmetrically about a vertical cross-sectional plane of said multipurpose protective respiratory headgear.

15. The cartridge as in claim 11, wherein said replaceable filter medium of said anteriorly mounted exchangeable filter cartridge is fillable in said essentially rectangular paralepidid shaped shell.

16. The cartridge as in claim 11, wherein said essentially rectangular paralepidid shaped shell comprises a plurality of anteriorly facing spacers disposed on an interior side of a posterior face of said rectangular paralepidid shaped shell.

17. The cartridge as in claim 11, wherein said anteriorly mounted exchangeable filter cartridge is affixable into said essentially rectangular horizontal recess of said multipurpose protective respiratory headgear, by an upper clip.

18. A method of using a multipurpose protective respiratory headgear, with anteriorly mounted exchangeable cartridge, comprises:
(a) providing a multipurpose protective respiratory headgear comprises:
(I) a superior portion, configured to fit tightly against an upper facial surface of a subject, comprising:
(i) a vizor portion, comprising a transparent material, configured to adjoin said facial surface around ocular regions of said subject;
(ii) at least one tab, configured to anchor an elastic strap;
(II) a nasolabial portion, configured to adjoin a lower facial surface around nasal and labial regions of said subject, said nasolabial portion comprising:
(i) an essentially triangular extrusion shape;
(ii) an essentially rectangular horizontal recess, configured to receive an exchangeable filter cartridge;
(iii) an essentially trapezoid shaped inlet aperture;
(b) providing an anteriorly mounted exchangeable filter cartridge,
(I) an essentially rectangular paralepidid shaped shell;
(II) an essentially rectangular anterior removable lid;
(III) a replaceable filter medium;
(IV) a structured posterior outlet aperture;
(V) an essentially trapezoid shaped posteriorly extending ridge, essentially surrounding said structured posterior outlet aperture;
(c) inserting said anteriorly mounted exchangeable filter cartridge into said essentially rectangular horizontal recess of said nasolabial portion of said protective respiratory headgear; wherein said inserting of said anteriorly mounted exchangeable filter cartridge into said essentially rectangular horizontal recess of said nasolabial portion of said protective respiratory headgear comprises inserting said essentially trapezoid shaped inlet aperture in said nasolabial portion of said protective respiratory headgear into said essentially trapezoid shaped posteriorly extending ridge on said anteriorly mounted exchangeable filter cartridge;
(d) releasing said anteriorly mounted exchangeable filter cartridge from said essentially rectangular horizontal recess in said nasolabial portion of said multipurpose protective respiratory headgear.

19. The method as in claim 19, wherein said anteriorly mounted exchangeable filter cartridge is affixable into said essentially rectangular horizontal recess of said multipurpose protective respiratory headgear, by an upper clip, wherein said inserting further comprises appending a bottom portion of said cartridge to a bottom portion of said essentially triangular extrusion and swiveling a top portion of said cartridge in a direction towards a top portion of said essentially triangular extrusion.
